(19) United States
(12) Patent Application Publication
(10) Pub. No.: US 2020/0039452 A1
(43) Pub. Date: Feb. 6, 2020

(54) PORTABLE COMMODE ASSEMBLY

(71) Applicant: Cynthia Survine, Fairfield, CA (US)

(72) Inventor: Cynthia Survine, Fairfield, CA (US)

(21) Appl. No.: 16/052,172

(22) Filed: Aug. 1, 2018

(51) Int. Cl. B60R 15/04; A47K 11/02

(52) U.S. Cl. CPC B60R 15/04; A47K 11/02

(57) ABSTRACT

A portable commode assembly for urinating or defecating during vehicular travel includes a vehicle that has at least one seat. A basin is positionable on the seat during vehicular travel, a bag is positioned in the basin and the bag is comprised of a fluid impermeable material. An absorbing panel is positionable in the bag and the absorbing panel is comprised of diatomaceous earth for absorbing fluid human waste. A cover is removably positioned on the basin and the cover is sat upon by a user. The cover has a waste opening extending therethrough to direct defecation or urination therethrough onto the absorbing panel.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to commode devices and more particularly pertains to a new commode device for urinating or defecating during vehicular travel.

### BRIEF SUMMARY OF THE INVENTION

An embodiment of the disclosure meets the needs presented above by generally comprising a vehicle that has at least one seat. A basin is positionable on the seat during vehicular travel, a bag is positioned in the basin and the bag is comprised of a fluid impermeable material. An absorbing panel is positionable in the bag and the absorbing panel is comprised of diatomaceous earth for absorbing fluid human waste. A cover is removably positioned on the basin and the cover is sat upon by a user. The cover has a waste opening extending therethrough to direct defecation or urination therethrough onto the absorbing panel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a portable commode assembly according to an embodiment of the disclosure.

FIG. 2 is a bottom view of an embodiment of the disclosure.

FIG. 3 is a top view of an embodiment of the disclosure.

FIG. 4 is an exploded perspective view of an embodiment of the disclosure.

FIG. 5 is a cross sectional view taken along line 5-5 of FIG. 4 of an embodiment of the disclosure.

FIG. 6 is a perspective in-use view of an embodiment of the disclosure.

FIG. 7 is a perspective view of an embodiment of the disclosure showing a cover and a basin being stored beneath a seat.

FIG. 8 is a phantom perspective view of an embodiment of the disclosure.

FIG. 9 is a front perspective in-use view of an embodiment of the disclosure.

### DETAILED DESCRIPTION OF THE INVENTION

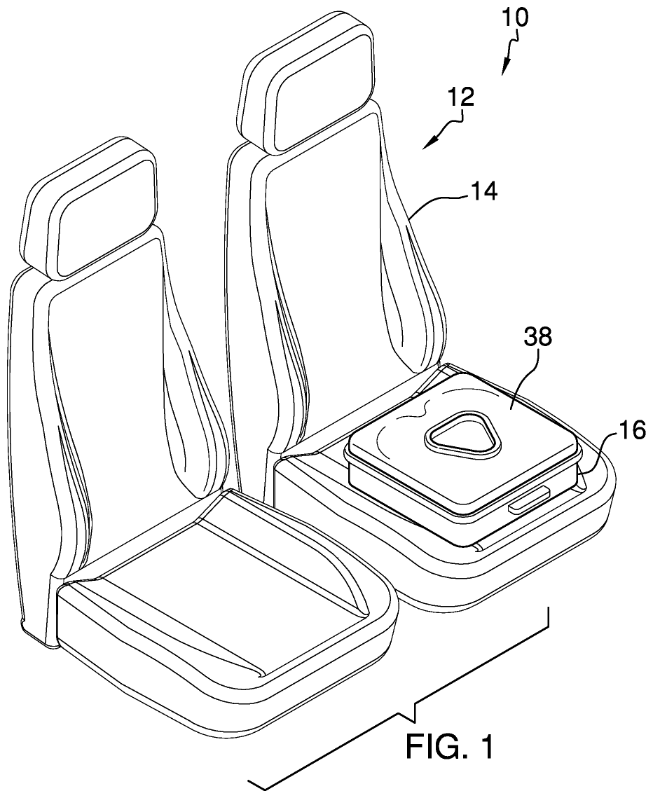

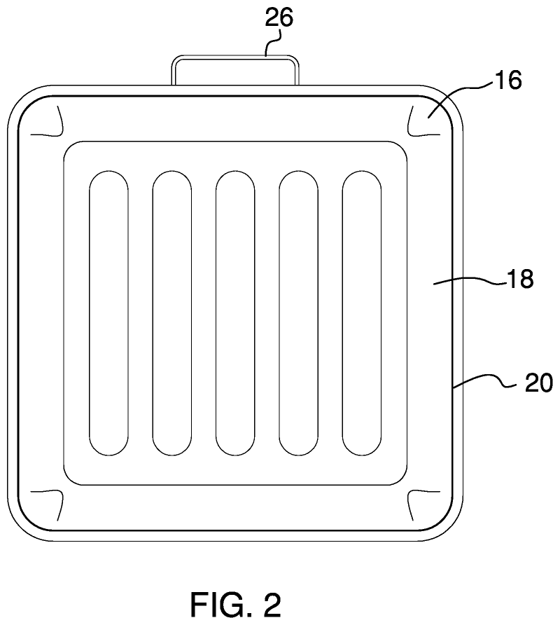

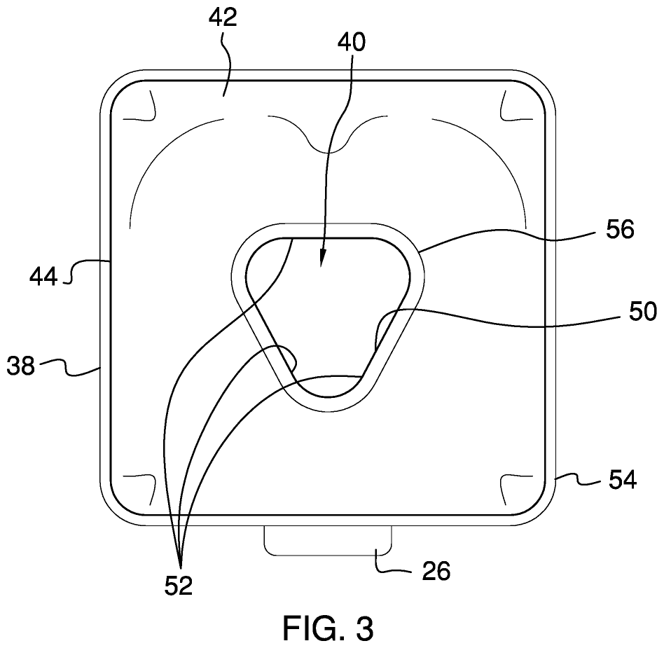

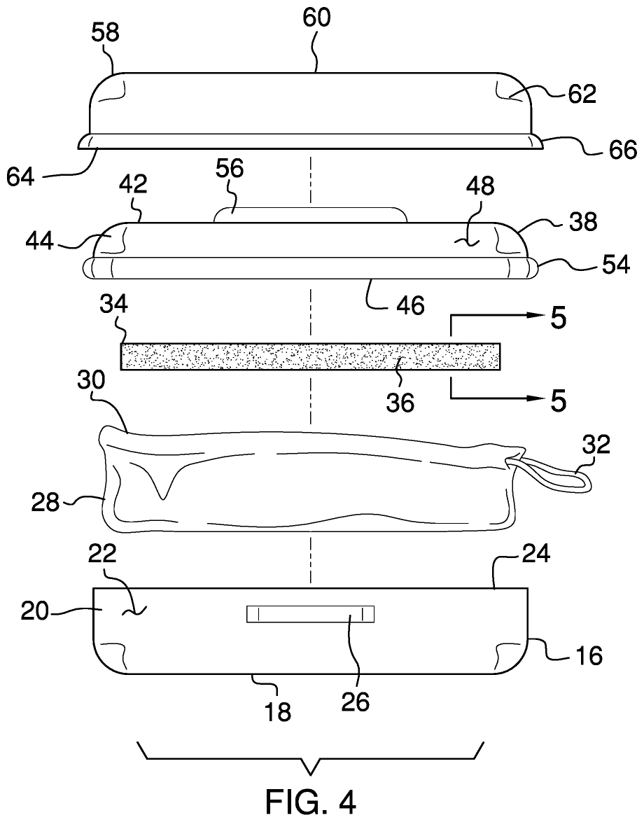

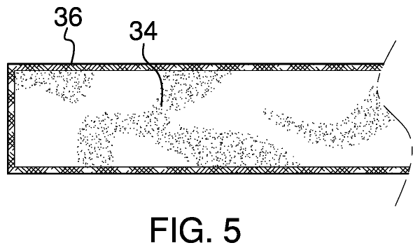

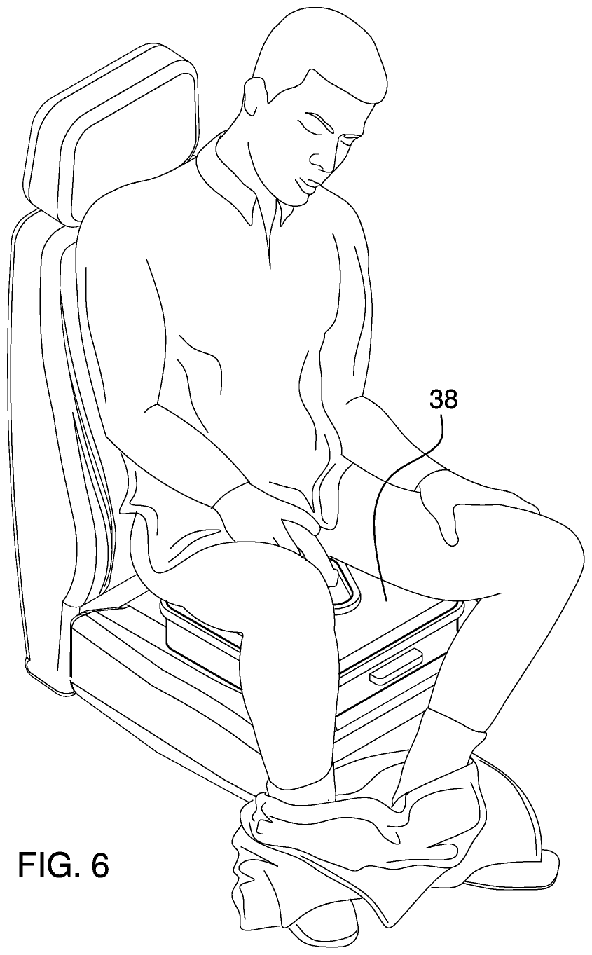

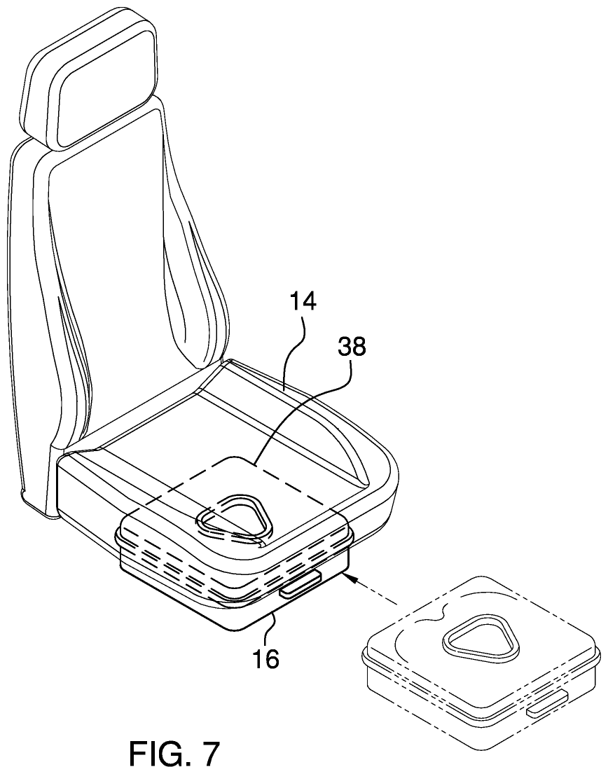

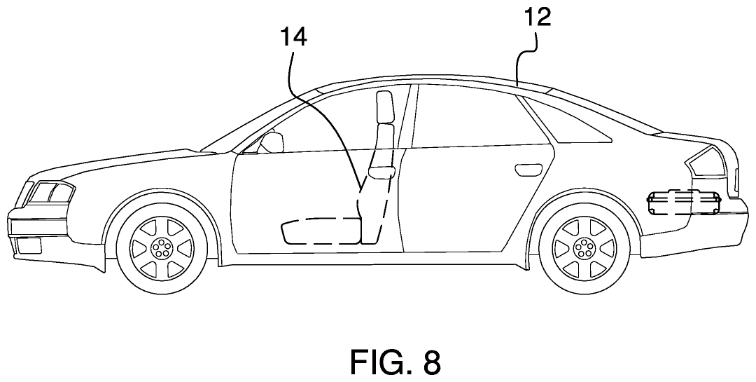

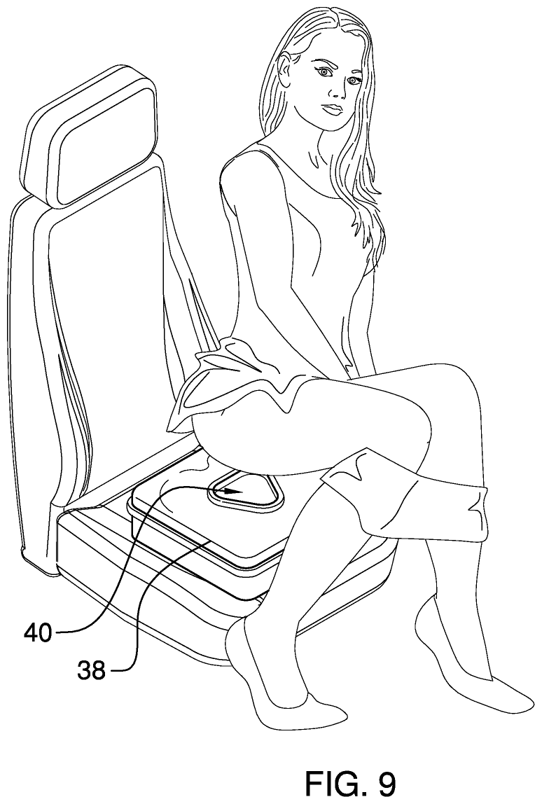

With reference now to the drawings, and in particular to FIGS. 1 through 9 thereof, a new commode device embodying the principles and concepts of an embodiment of the disclosure and generally designated by the reference numeral 10 will be described.

As best illustrated in FIGS. 1 through 9, the portable commode assembly 10 generally comprises a vehicle 12 that has at least one seat 14. The vehicle 12 may be a passenger vehicle such as a car or the like, a cargo vehicle such as a truck or the like, or any other type of motorized vehicle. A basin 16 is provided and the basin 16 is positionable on the at least one seat 14 during vehicular travel.

The basin 16 has a basal wall 18 and an outer wall 20 extending upwardly therefrom, and the outer wall 20 has an outside surface 22 and a distal edge 24 with respect to the basal wall 18. The basal wall 18 rests on the at least one seat 14 when the basin 16 is positioned thereon. A handle 26 is coupled to and extends away from the outer wall 20 of the basin 16 for gripping. A bag 28 is provided and the bag 28 is positionable in the basin 16. The bag 28 is comprised of a fluid impermeable material such as plastic or the like for capturing human waste. The bag 28 has a top end 30, the top end 30 is open and the bag 28 has a drawstring 32 thereon for closing the top end 30.

An absorbing panel 34 is provided and the absorbing panel 34 is positionable in the bag 28. The absorbing panel 34 is comprised of diatomaceous earth, such as clay or the like, thereby facilitating the absorbing panel 34 to absorb fluid human waste. A covering 36 is positioned around the absorbing panel 34 such that the covering 36 completely encloses the absorbing panel 34. Moreover, the covering 36 is comprised of a fluid permeable material such as cotton, synthetic fibers or other textile.

A cover 38 is removably positioned on the basin 16 and the cover 38 is sat upon by a user when the user has to defecate or urinate during vehicular travel. The cover 38 has a waste opening 40 extending therethrough to direct the defecation or urination therethrough onto the absorbing panel 34. The cover 38 has a top wall 42 and an exterior wall 44 extending downwardly therefrom, and the exterior wall 44 has a distal edge 46 with respect to the top wall 42 and an outer surface 48. The waste opening 40 extends through the top wall 42 and the waste opening 40 has a bounding edge 50. The bounding edge 50 has a plurality of intersecting sides 52 such that the waste opening 40 has a triangular shape and the waste opening 40 is centrally positioned on the top wall 42. The exterior wall 44 curves outwardly adjacent to the distal edge 46 of the exterior wall 44 to define a lip 54 on the cover 38, and the lip 54 engages the distal edge 24 of the outer wall 20 of the basin 16.

A ridge 56 is coupled to and extends upwardly from the top wall 42 of the cover 38. The ridge 56 is aligned with and is coextensive with the bounding edge 50 of the waste opening 40. Thus, the ridge 56 inhibits the urination or defecation from spilling onto the top wall 42 of the cover 38. A lid 58 is positionable over the cover 38 for storing the cover 38, the bag 28 and the absorbing panel 34. The lid 58 has an upper wall 60 and an outside wall 62 extending downwardly therefrom, and the outside wall 62 has a distal edge 64 with respect to the upper wall 60. The outside wall 62 curves outwardly adjacent to the distal edge 64 of the outside wall 62 to define a lip 66 on the outside wall 62. The lip 66 on the outside wall 62 of the lid 58 engages the lip 54 on the cover 38 when the lid 58 is positioned on the cover 38.

In use, the lid 58 is removed from the cover 38 and the basin 16 is positioned on the at least one seat 14 when the user needs to urinate or defecate during vehicular travel. The user mounts the cover 38 and the user urinates or defecates through the opening in the cover 38. The absorbing panel 34 absorbs fluid human waste and thusly reduces odors associated with the fluid human waste. The cover 38 is removed from the basin 16 when the user is finished relieving themselves, the bag 28 is removed from the basin 16 and the drawstring 32 is manipulated to close the bag 28. Thus, the bag 28 and the resulting waste can be discarded at any time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable commode assembly being configured to be transported in a vehicle for relieving oneself during vehicular travel, said assembly comprising:
a vehicle having at least one seat;
a basin being positionable on said seat during vehicular travel;
a bag being positioned in said basin, said bag being comprised of a fluid impermeable material;
an absorbing panel being positionable in said bag, said absorbing panel being comprised of diatomaceous earth wherein said absorbing panel is configured to absorb fluid human waste;
a cover being removably positioned on said basin wherein said cover is configured to be sat upon by a user, said cover having a waste opening extending therethrough wherein said waste opening is configured to direct defecation or urination therethrough onto said absorbing panel.

2. The assembly according to claim 1, wherein said basin has a basal wall and an outer wall extending upwardly therefrom, said outer wall having an outside surface and an distal edge with respect to said basal wall, said basal wall resting on said at least one seat when said basin is positioned thereon.

3. The assembly according to claim 1, further comprising a covering being positioned around said absorbing panel such that said covering completely encloses said absorbing panel, said covering being comprised of a fluid permeable material.

4. The assembly according to claim 1, wherein:
said cover has a top wall and an exterior wall extending downwardly therefrom, said exterior wall having a distal edge with respect to said top wall and an outer surface, said waste opening extending through said top wall, said waste opening having a bounding edge, said bounding edge having a plurality of intersecting sides such that said waste opening has a triangular shape, said waste opening being centrally positioned on said top wall;
said exterior wall curving outwardly adjacent to said distal edge of said exterior wall to define a lip on said cover, said lip engaging said distal edge of said outer wall of said basin; and
said top wall has a ridge being coupled to and extending upwardly therefrom, said ridge being aligned with and being coextensive with said bounding edge of said waste opening wherein said ridge is configured to inhibit the urination or defecation from spilling onto said top wall of said cover.

5. The assembly according to claim 4, further comprising a lid being positionable over said cover for storing said cover, said bag and said absorbing panel, said lid having an upper wall and an outside wall extending downwardly therefrom, said outside wall having a distal edge with respect to said upper wall, said outside wall curving outwardly adjacent to said distal edge of said outside wall to define a lip on said outside wall, said lip on said outside wall of said lid engaging said lip on said cover when said lid is positioned on said cover.

6. A portable commode assembly being configured to be transported in a vehicle for relieving oneself during vehicular travel, said assembly comprising:
a vehicle having at least one seat;
a basin being positionable on said at least one seat during vehicular travel, said basin having a basal wall and an outer wall extending upwardly therefrom, said outer wall having an outside surface and an distal edge with respect to said basal wall, said basal wall resting on said at least one seat when said basin is positioned thereon;
a bag being positioned in said basin, said bag being comprised of a fluid impermeable material, said bag having a top end, said top end being open, said bag having a drawstring thereon for closing said top end;
an absorbing panel being positionable in said bag, said absorbing panel being comprised of diatomaceous earth wherein said absorbing panel is configured to absorb fluid human waste;
a covering being positioned around said absorbing panel such that said covering completely encloses said absorbing panel, said covering being comprised of a fluid permeable material;
a cover being removably positioned on said basin wherein said cover is configured to be sat upon by a user, said cover having a waste opening extending therethrough wherein said waste opening is configured to direct defecation or urination therethrough onto said absorbing panel, said cover having a top wall and an exterior wall extending downwardly therefrom, said exterior wall having a distal edge with respect to said top wall and an outer surface, said waste opening extending through said top wall, said waste opening having a bounding edge, said bounding edge having a plurality of intersecting sides such that said waste opening has a triangular shape, said waste opening being centrally positioned on said top wall, said exterior wall curving outwardly adjacent to said distal edge of said exterior wall to define a lip on said cover, said lip engaging said distal edge of said outer wall of said basin;
a ridge being coupled to and extending upwardly from said top wall of said cover, said ridge being aligned with and being coextensive with said bounding edge of said waste opening wherein said ridge is configured to inhibit the urination or defecation from spilling onto said top wall of said cover; and
a lid being positionable over said cover for storing said cover, said bag and said absorbing panel, said lid having an upper wall and an outside wall extending downwardly therefrom, said outside wall having a distal edge with respect to said upper wall, said outside wall curving outwardly adjacent to said distal edge of said outside wall to define a lip on said outside wall, said lip on said outside wall of said lid engaging said lip on said cover when said lid is positioned on said cover.
